(19) United States
(12) Patent Application Publication
(10) Pub. No.: US 2006/0178826 A1
(43) Pub. Date: Aug. 10, 2006

(54) Navigation device and program product for displaying magnified intersection view

(75) Inventor: Akihiro Gomi, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/332,200

(22) Filed: Jan. 17, 2006

(30) Foreign Application Priority Data
Feb. 7, 2005 (JP) 2005-030302

(51) Int. Cl. G01C 21/34

(52) U.S. Cl. 701/211; 340/995.1; 701/200

(57) ABSTRACT

A navigation device for a vehicle selects, as facilities for displaying with a magnified view of a guidance intersection on a recommended route to a destination, only facilities along an entering road through which the recommended route goes just before entering the guidance intersection and facilities at the corners of the guidance intersection. Then the navigation device displays the magnified view and the selected landmarks together.

### CROSS REFERENCE TO RELATED APPLICATION

This application is based on and incorporates herein by reference Japanese patent applications No. 2005-30302 filed on Feb. 7, 2005.

### FIELD OF THE INVENTION

The present invention relates to a navigation device and a program product for displaying a magnified view of an intersection along a recommended route to a destination.

### BACKGROUND OF THE INVENTION

A conventional navigation device displays a magnified view of a given intersection so as to instruct a relevant vehicle with the navigation device to not go off a recommended route to a destination. Here, this given intersection is a diverging point; for instance, at the given intersection, the relevant vehicle needs to turn or change roads without going in a straight traffic line or going in a traffic line supposed to be a straight line. Hereinafter, this given intersection is called a guidance intersection as an intersection needing guidance for not going off the recommended route. A navigation device (e.g., a navigation device described in JP H8-75489A) further displays a landmark of a facility on the magnified view.

An entering road on which the vehicle runs up to the guidance intersection may be surrounded by tall buildings. In this case, a driver of the vehicle cannot see, from the entering road, facilities located along roads (except the entering road) connected to the guidance intersection such as an exiting road. The exiting road is a road which the vehicle enters just after exiting the guidance intersection along the recommended route. If the navigation device displays, on the magnified intersection view, the landmarks of the facilities which cannot seen by the driver, the driver may try to find the facilities ahead of the vehicle in vain and thereby fall into a lapse of attention.

### SUMMARY OF THE INVENTION

It is therefore an object of the present invention to provide a navigation device for displaying a magnified view of an intersection on a recommended route to a destination, which can preferentially display a facility which is easily seen by a driver with the magnified view.

To achieve the above object, a navigation device is provided with the following: When approaching an intersection on a route to a destination, route guidance is performed by displaying a magnified view of the intersection. A storage medium is included for storing address range data for links connected to the intersection. In the address range data each of the links is correlated with a house number range including house numbers. The house numbers are given along the each of the links in ascending order. A controlling circuit is included for selecting, based on the address range data, a facility corresponding to a house number within house number ranges correlated with the links connected to the intersection. An image display device is included for displaying, together with the magnified view of the intersection, a landmark of the facility selected by the control circuit.

### BRIEF DESCRIPTION OF THE DRAWINGS

The invention, together with additional objective, features and advantages thereof, will be best understood from the following description, the appended claims and the accompanying drawings. In the drawings:

FIG. 1 is a block diagram showing a hardware structure of a navigation device according to an embodiment of the present invention;

FIG. 2 is a schematic top view showing roads to which the navigation device is adapted;

FIG. 3 is a table of an example of address range data memorized by an external storage device of the navigation device;

FIG. 4 is a table of an example of facility data memorized by the external storage device;

FIG. 5 is a flowchart showing a program executed by a CPU of the navigation device; and

FIGS. 6 and 7 are schematic magnified intersection views displayed by an image display device of the navigation device.

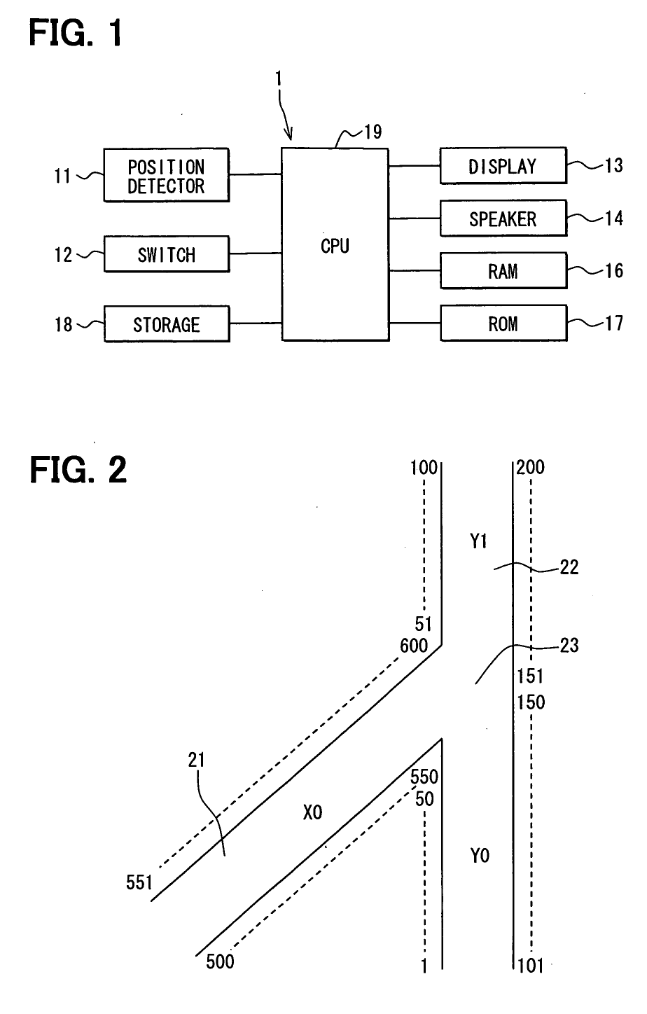

### DETAILED DESCRIPTION OF THE PREFERRED EMBODIMENTS

Hereinafter, an embodiment of the present invention will be described. A navigation device 1 for a vehicle according to the embodiment displays a magnified view of a guidance intersection and a landmark with the magnified view and the landmark overlapped with each other. Here, the guidance intersection means an intersection at which the subject vehicle with the navigation device 1 is required to turn or change roads so as to follow a recommended route to a destination or so as not to go off the recommended route, as previously explained. In other words, at the guidance intersection, guidance for turning or changing roads is required by a user of the subject vehicle or the navigation device 1.

The navigation device 1 includes a position detector 11, operation switches 12, an image display device 13, a speaker 14, a RAM 16, a ROM 17, an external storage device 18, and a CPU 19.

The position detector 11 includes sensors (such as a geomagnetic sensor, a gyroscope, a vehicle speed sensor, and a GPS receiver) to output signals characterized by the sensors for specifying a current position and/or a direction of the vehicle.

The operation switches 12 include input devices such as mechanical switches attached to the surface of the navigation device 1 and a touch panel on a screen of the image display device 13. Additionally, the operation switches 12 output signals to the CPU 19 based on depressing the mechanical switches or touching the touch panel by a user.

The image display device 13 displays images based on video signals from the CPU 19. The images to be displayed are, for example, a map view around a current position.

The external storage device 18 is a nonvolatile storage medium such as an HDD. The external storage device 18 stores programs which the CPU 19 reads and executes, and map data for route guidance.

The map data indicates a geographical area in which house numbers are given in ascending order along a road: each of the house numbers is an address of an area and usually used to specify a facility (or a building) on the area. Such a geographical area assigned house numbers (hereinafter referred to as an ordered geographical area) is usually seen in United States of America and Europe.

FIG. 2 shows an example regarding a road structure and a way of giving the house numbers for the ordered geographical area. In FIG. 2, the upward direction and the rightward direction correspond to the directions to the north and the east, respectively. The ordered geographic area in FIG. 2 includes an X street 21 going straight from the southwest to the northeast and a Y street 22 going straight from the south to the north. The X street 21 joins the Y street 22 at an intersection 23. The house numbers are given to facilities along the X street 21 and the Y street 22 in such a manner as shown in FIG. 2.

Specifically, in a first travel direction from the southwest to the northeast along the X street 21, facilities located along the right side of the X street 21 are given house numbers one by one in ascending order from 500 to 550. Moreover, facilities located along the left side of the X street 21 are given house numbers one by one in ascending order from 551 to 600 in the first travel direction. Naturally, the house numbers 551 to 600 are given in descending order when seen in a direction opposite to the first travel direction.

In a second travel direction from the south to the north along the Y street 22, facilities located along the right side of the Y street 22 are given house numbers one by one in ascending order from 101 to 200. Moreover, facilities located along the left side of the Y street 22 are given house numbers one by one in ascending order from 1 to 100 in the second travel direction. The house numbers 150 and 151 are given to the facilities just to the right of the intersection 23 in the second direction.

The house numbers 50 and 51 are given to the facilities located just to the south and the north of a junction where the X street 21 joins the Y street 22, respectively.

In the ordered geographic area where the house numbers are given in ascending order along the roads, one of the facilities can be uniquely specified by designating a name of a specific street and a specific house number, like “X street No. 520” or “Y street No. 43.”The map data described above include road data describing nodes and roads, and facility data describing facilities located along the roads. Each of the roads is described by the road data as one or more links connecting two of the nodes.

The road data include information regarding positions and kinds of the links and nodes, and information regarding how the links and the nodes are connected. The road data further include address range data in which each of the links is correlated with one or more of address ranges. Each of the address ranges specifies a house number range of the above described house numbers. An address range correlated with a link is a house number range of house numbers given to locations along a part of a road corresponding to the link.

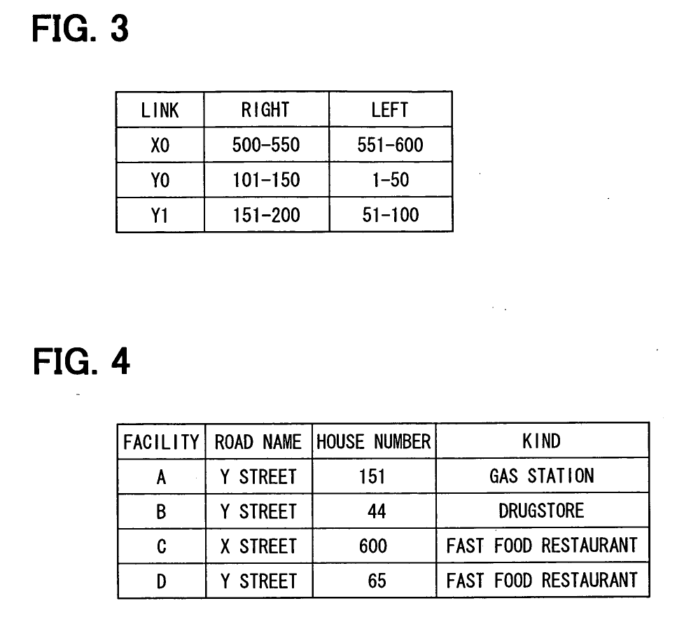

As shown in FIG. 3, the address range data have a table including multiple records, each of which corresponds to a link. Each of the multiple records is a dataset including a link identifier for identifying the corresponding link, an address range given to locations along the right side of the corresponding link, and an address range given to locations along the left side of the corresponding link.

For example, as for a link X0 in FIG. 3, which corresponds to the X street 21 shown in FIG. 2, the address range along the right side is from 500 to 550, while the address range along the left side is from 551 to 600. As for a link Y0 in FIG. 3, which corresponds to a part of the Y street 22 in FIG. 2 connected to the south side of the intersection 23, the address range along the right side is from 101 to 150, while the address range along the left side is from 1 to 50. As for a link Y1 in FIG. 3, which corresponds to a part of the Y street 22 connected to the north side of the intersection 23, the address range along the right side is from 151 to 200, while the address range along the left side is from 51 to 100.

In the address range data, right or left of a link means right or left in a direction from the start point of the link to the end point of the link. Allocation of the start point and the end point of a link to the both ends of the link can be determined according to data for allocation included beforehand in the map data. Otherwise, allocation can be determined in a predetermined manner, for example, that the start point of the link is an end of the link with which a node with a smaller identification number is connected and that the end point of the link is the other end of the link with which a node with a larger identification number is connected. In the example shown in FIGS. 2 and 3, the start point of the link X0 is the southwest end of the X street 21 and the end point of the link X0 is the intersection 23. The start point of the link Y0 is the south end of the Y street 22 and the end point of the link Y0 is the intersection 23. The start point of the link Y1 is the intersection 23 and the end point of the link Y1 is the north end of the Y street 22.

The facility data include multiple records each of which corresponds to a facility. Each of the multiple records includes a name, a position, a kind, and a landmark (or logo) of a corresponding facility. Specifically, as shown in FIG. 4, the facility data have a table including multiple records, each of which is a dataset including a name of a corresponding facility, a name of street the corresponding facility faces, a house number given to the corresponding facility, and a kind of the corresponding facility.

The CPU 19 reads and executes programs for operations of the navigation device 1 stored in the ROM 17 and external storage device 18. During execution of the programs, the CPU 19 retrieves information from the RAM 16, the ROM 17, and the external storage device 18, stores the information on the RAM 16 and the external storage device 18, and exchanges signals with the position detector 11, the operation switches 12, the image display device 13, and the speaker 14.

The CPU 19 executes the programs to perform processes such as position determination, recommended route calculation, and route guidance.

By executing the position determination, the CPU 19 specifies a current position and/or a current heading direction of the vehicle, based on the signals from the position detector 11 by using techniques such as well-known map-matching algorithm.

By executing the recommended route calculation, the CPU 19 accepts user's designation of a destination through the operation switches 12, and calculates the optimum recommended route from the current position to the destination. The calculated recommended route is a single path constructed by links and nodes.

By executing the route guidance, the CPU 19 retrieves the map data from the external storage device 18 and outputs to the image display device 13 a map view with the recommended route and the current position mark laid thereon. Furthermore, when necessary (for example, each time the vehicle approaches a guidance intersection), the CPU 19 outputs to the speaker 14 guidance sound signals indicating turning left or right, and outputs a magnified (or enlarged) view of the guidance intersection.

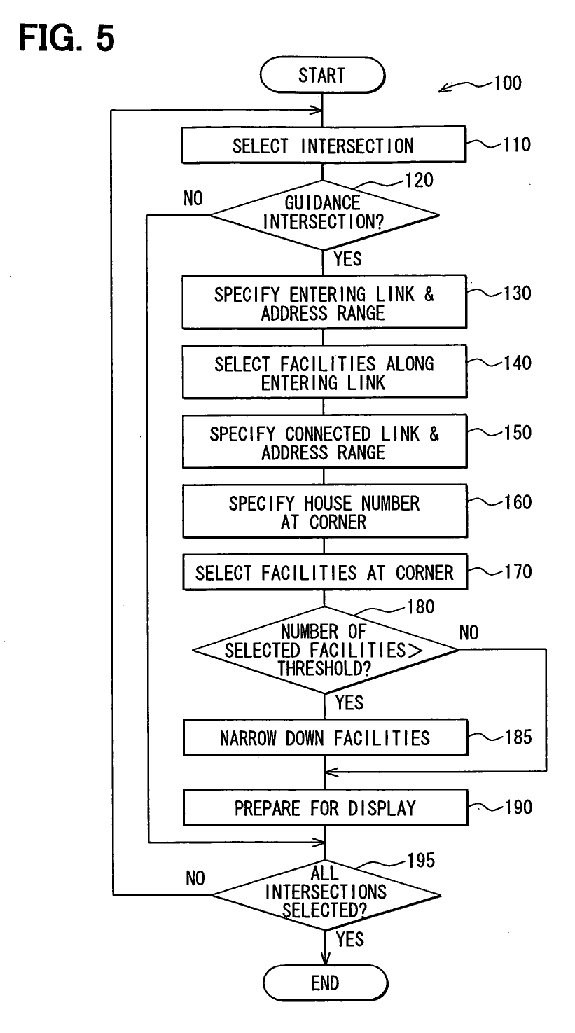

The CPU 19 also executes, after the execution of the recommended route calculation, a program 100 shown in FIG. 5 as a flowchart. The program 100 is for making step by step preparation of displaying magnified views of guidance intersections on a recommended route calculated by the recommended route calculation. In the route guidance, the CPU 19 causes, based on the preparation, the image display device 13 to display the magnified views of the guidance intersections.

In an execution of the program 100, the CPU 19 first selects at Step 110 an intersection (hereinafter referred to as a selected intersection) which have not been selected at this time by the execution of the program 100 from within all intersections on the recommended route and is closest to the start point of the recommended route.

At Step 120, the CPU 19 executes a determination whether the selected intersection is a guidance intersection (or whether or not the vehicle is required at the selected intersection to not continuously advance a road the vehicle has been advancing up to the selected intersection for the purpose of following the recommended route). When the determination at Step 120 is affirmative, the CPU 19 subsequently executes Step 130. When the determination at Step 120 is negative, the CPU 19 subsequently executes Step 195.

At Step 130, the CPU 19 specifies an entering link and address ranges along the entering link. This entering link is a link on which the vehicle runs just before entering the selected intersection. The entering link can be specified using data indicating the recommended route. The address ranges along the entering link can be specified based on address ranges for the left side and the right side in the record of the address range data table in FIG. 3 including the identifier of the entering link.

At Step 140, the CPU 19 selects, based on the address ranges specified at Step 130, facilities along the entering link as candidate facilities for displaying. The CPU 19 searches, from the facility data table shown in FIG. 4, records having house number within the specified address ranges, and stores in the RAM 16 the facilities corresponding the found records as the candidate facilities for displaying.

At Step 150, the CPU 19 specifies connecting links and address ranges along the connecting links. The connecting links are all links connected with the selected intersection. The address ranges along the connecting links can be specified based on address ranges to the left side and address ranges to the right side in the records of the address range data including the identifiers of the connecting links.

At Step 160, the CPU 19 specifies house numbers each of which corresponds to a corner formed by one of the connecting links and the selected intersection. Here, the CPU 19 determines, based on the map data or the predetermined manner, which of the start point or the end point of each connecting link is connected to the selected intersection. Then the CPU 19 specifies each house number located at either the start point or end point determined to be connected to the selected intersection. When the intersection 23 in FIG. 2 is the selected intersection, the corners with the selected intersection are corresponded to by the house numbers 600 and 550 along the link X0, the house numbers 50 and 150 along the link Y0, and the house numbers 51 and 151 along the link Y1.

At Step 170, the CPU 19 selects facilities at the corners with the selected intersection as the candidate facilities for displaying by searching from the facility data in FIG. 4 facilities provided with the house numbers specified at Step 160.

At Step 180, the CPU 19 executes a determination whether the number of the selected facilities is larger than a threshold. The number of the selected facilities is a total sum of the numbers of the facilities selected at Step 140 and Step 170 as the candidate facilities for displaying. The threshold has a predetermined value such as 4. When the determination at Step 180 is affirmative, the CPU 19 then executes Step 185. When the determination at Step 180 is negative, the CPU 19 then executes Step 190.

At Step 185, the CPU 19 narrows down the candidate facilities for displaying. The CPU 19 reduces the number of the candidate facilities for displaying below the threshold (e.g. 4). Facilities preferentially kept as the candidate facilities for displaying are (i) facilities along the entering link and (ii) facilities at corners formed between the selected intersection and an exiting link on which the vehicle runs just after exiting the selected intersection. In the case that the number of the candidate facilities for displaying after narrowing down is still more than the threshold, the CPU 19 completes reducing the number to the threshold, e.g., by preferentially keeping facilities selected earlier.

At Step 190, the CPU 19 executes preparation for displaying a magnified view of the selected intersection. The CPU 19 stores facilities selected and then kept in the candidate facilities in the RAM 16, by correlating these facilities with the selected intersection.

At Step 195, the CPU 19 executes a determination whether all the intersections on the recommended route has been already selected in this execution of the program 100. When the determination at Step 195 is affirmative, the CPU 19 terminates the execution of the program 100. When the determination at Step 195 is negative, the CPU 19 executes Step 110 again.

Through the execution of the program 100 by the CPU 19, for every guidance intersection on the recommended route to the destination (see Step 195), the navigation device 1 selects (see Step 140), as a part of the candidate facilities for displaying, the facilities along the entering link to the guidance intersection based on the address ranges for the entering link (see Step 130). Then the CPU 19 selects (see Step 170), as another part of the candidate facilities for displaying, the facilities located close to one of the corners of the guidance intersection based on the ends of the address ranges for the connecting links (see Steps 150 and 160). In the case that the number of selected candidate facilities is more than the threshold (see Step 180), the CPU 19 narrows down (see Step 185) the number of the candidate facilities while preferentially keeping the facilities along the entering link and the facilities located close to (or at) the corners formed between the selected intersection and the existing link. Then the CPU 19 executes a preparation process (see Step 190) for displaying only landmarks, which are narrowed down or extracted from the candidate facilities, on the magnified view of the guidance intersection.

In addition, each time the vehicle comes as close as a predetermined interval (e.g. 700 meters) to one of the guidance intersections, the CPU 19 reads from the RAM 16 the candidate facilities for displaying corresponding to the guidance intersection, and causes the image display device 13 to display an image of the magnified view of the guidance intersection and landmarks of the candidate facilities laid on the magnified view. In this case, a position of a landmark of a certain facility on the magnified view is calculated based on (i) the house number of the certain facility and (ii) an address range including this house number along a link (hereinafter a facing link) which the certain facility faces. The CPU 19 determines the position of the landmark based on an assumption that house numbers within this address range along the facing link are located with even intervals and the house numbers corresponding to both ends of the address range is located at both ends (start point and end point) of the facing link.

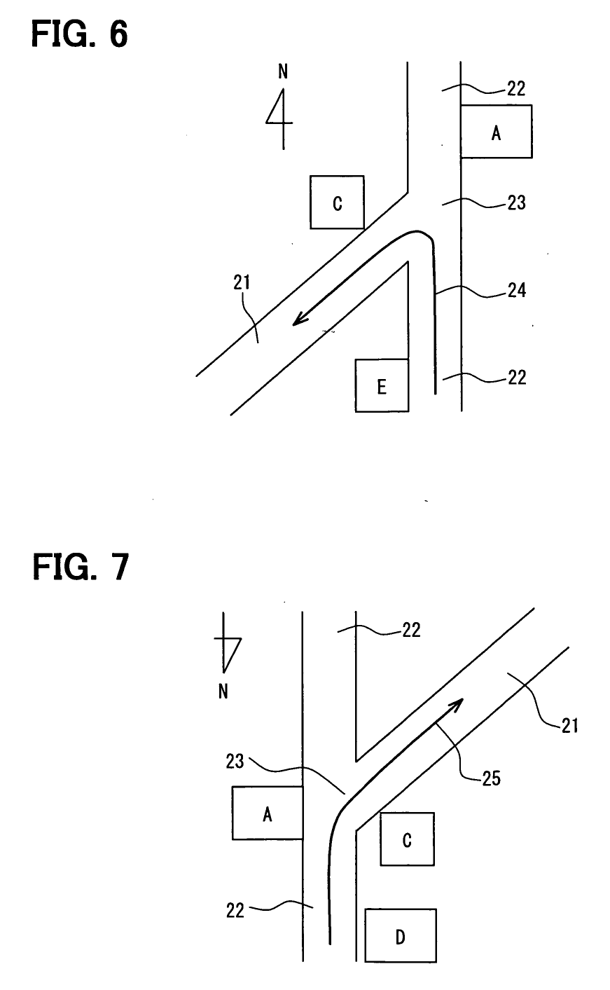

In a magnified view of an intersection shown in FIG. 6, a recommended route 24 goes along the Y street 22 shown in FIG. 2 from the south to the north, turns left at the intersection 23, and enters the X street 21. In displaying the magnified view of FIG. 6, the CPU 19 causes the image display device 13 to display the magnified view with only three landmarks selected for displaying by an execution of the program 100: The landmarks correspond to a facility B along the Y street 22 (i.e. the entering link), a facility A near a corner of the intersection 23, and a facility C near a corner of the intersection 23 along the X street 21 (i.e. the exiting link).

In another magnified view of an intersection shown in FIG. 7, a recommended route 25 goes along the Y street 22 shown in FIG. 2 from the north to the south, turns right at the intersection 23, and enters the X street 21. Note that in FIG. 7, the upward direction and the rightward direction correspond to the directions to the south and the west, respectively; namely, FIG. 7 is turned upside down compared with FIG. 6. In displaying the magnified view of FIG. 7, the CPU 19 causes the image display device 13 to display the magnified view with only three landmarks selected for displaying by an execution of the program 100: The landmarks correspond to a facility D along the Y street 22 (i.e. the entering link), a facility A near a corner of the intersection 23, and a facility C near a corner of the intersection 23 along the X street 21 (i.e. the exiting link).

Thus, the navigation device 1 displays, by using the image display device 13, landmarks of facilities as an overlaid image on a magnified view of every guidance intersection on a recommended route to a destination. For instance, the facilities selected for the magnified view are limited to those along an entering link to the guidance intersection and near corners of the guidance intersection. This helps prevent display of facilities that are hidden or excluded from the field of a driver's vision, thereby relieving the driver from uselessly searching practically invisible facilities even though landmarks of the invisible facilities are shown on the magnified view. The driver's attention to the intersection can be thereby maintained.

In addition, facilities along the entering link and facilities at corners with the exiting link of the guidance intersection are more preferentially selected as the facilities for displaying than other facilities (e.g., facilities at corners of the guidance intersection with the connecting links other than the entering link and the exiting link, and facilities along the connecting links other than the entering link). Thus, in displaying the magnified view of every guidance intersection on the recommended route to the destination, the navigation device 1 can preferentially display, with the magnified view, facilities easy to find ahead of the vehicle, thereby facilitating the route guidance.

In addition, in every guidance intersection connecting two roads along which house numbers are given in ascending order, the navigation device 1 identifies facilities at the corners of the guidance intersection to be the facilities corresponding to the house numbers at ends of the address ranges correlated with the connecting links in the address range data. Thus, it is possible to identify the facilities at the corners of the guidance intersection by utilizing the characteristic of the roads connected with the guidance intersection in which house numbers are given in ascending order along the roads.

In the above embodiment, the CPU 19 is an example of the controlling circuit. In addition, the CPU 19 is operated as a selecting means by executing Steps 130 to 185 in the program 100 and is operated as a display control means by executing Step 190.

### Other Embodiments

In the navigation device 1, the external storage device 18 may store data in which each group of (i) an intersection, (ii) an entering link, and (iii) an exiting link is correlated with multiple facilities for displaying. In this case, when the vehicle approaches (or comes close) to a guidance intersection, the navigation device 1 may display landmarks of the facilities correlated in this data with the group of (i) the guidance intersection, (ii) the entering link to the guidance intersection along the recommended route to the destination, and (iii) the exiting link of the guidance intersection along the recommended route, by overlaying the landmarks on a magnified view of the guidance intersection.

In the above embodiment, the house numbers are given along the roads one by one serially in ascending order. The house numbers, however, do not need to be given one by one serially. For example, the house numbers may be given alternately in ascending order. The address range data may include data regarding a way (e.g. serially or alternately) of giving house numbers as well as address ranges for each of the links.

In a road, the house numbers can be given in ascending order alternately to both sides of the road one by one. For instance, when the house numbers from 500 to 600 are given along the X street 21 in FIG. 2 in this manner, facilities along the right side of the X street 21 are given the even house numbers 500, 502, 504, . . . , and 600 in ascending order in the direction from the southwest to the northeast: Facilities along the left side of the X street 21 are given the odd house numbers 501, 503, 505, . . . , and 599 in ascending order in the direction from the southwest to the northeast.

Likewise, when the house numbers from 1 to 200 are given along the Y street 22 in FIG. 2 in the above manner, facilities along the right side of Y street 22 are given the even house numbers 2, 4, 6, . . . , and 200 in ascending order in the direction from the south to the north: Facilities along the left side of the Y street 22 are given the odd house numbers 1, 3, 5, . . . , and 199 in ascending order in the direction from the south to the north.

Here, the house numbers given at the intersection 23 to the right side of the Y street 22 are 50 and 52. The house number given to a point just to the south of the junction where the X street 21 and the Y street 22 intersect is 49, while a point just to the north is 51.

For roads which are given the house numbers in this manner, the address range data table shown in FIG. 3, and the facility data table shown in FIG. 4 are composed accordingly. House numbers 49, 50, 51, 52, 559, and 600 corresponding to the facilities at the corners of the intersection 23 are specified in the address range data table; then, the facilities corresponding to the specified house numbers are found in the facility data table. This enables the facilities at the corners of the intersection to be selected for displaying: The selected facilities are then displayed on the magnified view of the intersection of the image display device 13.

The landmarks of the facilities do not need to be displayed on the magnified views of the intersections. For example, letters (which are also regarded as landmarks) indicating the names of the facilities may be displayed as a list located beside the magnified views.

The navigation device of the present invention does not need to be the navigation device 1 for the vehicle. For example, the navigation device of the present invention may be a portable navigation device which a user can take along.

Further, the selected intersection or the guidance intersection is explained using the example of a junction of three links shown in FIGS. 2, 6, 7; however, any intersection being a junction of multiple roads or links can be a selected intersection or a guidance intersection adaptable to the embodiment of the present invention.

It will be obvious to those skilled in the art that various changes may be made in the above-described embodiments of the present invention. However, the scope of the present invention should be determined by the following claims.

What is claimed is:

1. A navigation device for performing, when approaching an intersection on a route to a destination, route guidance by displaying a magnified view of the intersection, comprising:
a storage medium for storing address range data for links connected to the intersection, in the address range data each of the links being correlated with a house number range including house numbers, the house numbers being given along the each of the links in ascending order;
a controlling circuit for selecting, based on the stored address range data, a facility corresponding to a house number within house number ranges correlated with the links connected to the intersection; and
an image display device for displaying, together with the magnified view of the intersection, a landmark of the facility selected by the control circuit.

2. The navigation device according to claim 1, wherein,
the controlling circuit selects multiple facilities corresponding to house numbers within the house number ranges correlated with the links connected to the intersection, and
the image display device displays, together with the magnified view of the intersection, landmarks of the multiple facilities selected by the control circuit, wherein a number of the multiple facilities is predetermined.

3. A navigation device for performing, when approaching an intersection on a route to a destination, route guidance by displaying a magnified view of the intersection, comprising:
a storage medium for storing address range data for links connected to the intersection, in the address range data each of the links being correlated with a house number range including house numbers, the house numbers being given along the each of the links in ascending order;
a controlling circuit for selecting as a facility at a corner of the intersection, based on the stored address range data, a facility corresponding to a house number at an end of one of house number ranges correlated with the links connected to the intersection; and
an image display device for displaying, together with the magnified view of the intersection, a landmark of the facility selected as the facility at the corner by the control circuit.

4. The navigation device according to claim 3, wherein,
the controlling circuit further selects, based on the stored address range data, a certain facility corresponding to a house number within a house number range correlated with an entering link, through the entering link the route to the destination going just before entering the intersection, and
the image display device further displays a landmark of the certain facility selected by the control circuit.

5. The navigation device according to claim 4, wherein
the link correlated with the house number range including the house number corresponding to the facility selected as the facility at the corner is an exiting link, through the exiting link the route to the destination going just after exiting the intersection.

6. The navigation device according to claim 5, wherein,
the controlling circuit selects multiple facilities corresponding to house numbers within the house number ranges correlated with the links connected to the intersection, wherein the facility selected as the facility at the corner and the certain facility are included in the multiple facilities, and
the image display device displays, together with the magnified view of the intersection, landmarks of the multiple facilities selected by the control circuit, wherein a number of the multiple facilities is predetermined.

7. A navigation device for performing, when approaching an intersection on a route to a destination, route guidance by displaying a magnified view of the intersection, comprising:
a storage medium for storing address range data for links connected to the intersection, in the address range data each of the links being correlated with a house number range including house numbers, the house numbers being given along the each of the links in ascending order;
a controlling circuit for selecting, based on the stored address range data, a given facility corresponding to a house number at an end of a house number range correlated with an exiting link, through the exiting link the route to the destination going just after exiting the intersection; and
an image display device for displaying, together with the magnified view of the intersection, a landmark of the given facility selected by the control circuit.

8. The navigation device according to claim 7, wherein,
the controlling circuit further selects, based on the stored address range data, a certain facility corresponding to a house number within a house number range correlated with an entering link, through the entering link the route to the destination going just before entering the intersection, and
the image display device further displays a landmark of the certain facility selected by the control circuit.

9. The navigation device according to claim 8, wherein,
the controlling circuit selects multiple facilities corresponding to house numbers within the house number ranges correlated with the links connected to the intersection, wherein the given facility and the certain facility are included in the multiple facilities, and
the image display device displays, together with the magnified view of the intersection, landmarks of the multiple facilities selected by the control circuit, wherein a number of the multiple facilities is predetermined.

10. A computer program product for performing, when approaching an intersection on a route to a destination, route guidance by displaying a magnified view of the intersection, comprising a computer program mechanism embedded in a computer readable medium for causing a computer to:
read, from a storage medium, address range data for links connected to the intersection, in the address range data each of the links being correlated with a house number range including house numbers, the house numbers being given along the each of the links in ascending order;
select, based on the address range data, a facility corresponding to a house number within house number ranges correlated with the links connected to the intersection; and
cause an image display device to display, together with the magnified view of the intersection, a landmark of the selected facility .

11. A computer program product for performing, when approaching an intersection on a route to a destination, route guidance by displaying a magnified view of the intersection, comprising a computer program mechanism embedded in a computer readable medium for causing a computer to:
read, from a storage medium, address range data for links connected to the intersection, in the address range data each of the links being correlated with a house number range including house numbers, the house numbers being given along the each of the links in ascending order;
select as a facility at a corner of the intersection, based on the address range data, a facility corresponding to a house number at an end of one of house number ranges correlated with the links connected to the intersection; and
cause an image display device to display, together with the magnified view of the intersection, a landmark of the facility selected as the facility at the corner.

12. A computer program product for performing, when approaching an intersection on a route to a destination, route guidance by displaying a magnified view of the intersection, comprising a computer program mechanism embedded in a computer readable medium for causing a computer to:
read, from a storage medium, address range data for links connected to the intersection, in the address range data each of the links being correlated with a house number range including house numbers, the house numbers being given along the each of the links in ascending order;
select, based on the address range data, a given facility corresponding to a house number at an end of a house number range correlated with an exiting link, through the exiting link the route to the destination going just after exiting the intersection; and
cause an image display device to display, together with the magnified view of the intersection, a landmark of the selected given facility.
